(19) United States
(12) Patent Application Publication
(10) Pub. No.: US 2024/0250533 A1
(43) Pub. Date: Jul. 25, 2024

(54) SYSTEMS AND METHODS FOR MAKING ELECTRICAL DEVICES MORE FLEXIBLE TO OVERCOME BEHIND-THE-METER INFRASTRUCTURE CONSTRAINTS

(71) Applicant: Stepwise Electric, Inc., Buffalo, NY (US)

(72) Inventors: Austin Hunt, Buffalo, NY (US); Jane Chen, Buffalo, NY (US); Ethan Brewer, Buffalo, NY (US)

(73) Assignee: Stepwise Electric, Inc., Buffalo, NY (US)

(21) Appl. No.: 18/418,941

(22) Filed: Jan. 22, 2024

Related U.S. Application Data
(60) Provisional application No. 63/440,123, filed on Jan. 20, 2023.

(51) Int. Cl. H02J 3/14; H02J 3/00

(52) U.S. Cl. CPC H02J 3/144; H02J 3/00125; H02J 2310/14; H02J 2310/52; H02J 2310/60

(57) ABSTRACT

An energy orchestration module (EOM) is provided to dynamically power flexible loads such as electric vehicle batteries, water heaters, and heating ventilation and air conditioning (HVAC) systems. The EOM can monitor energy use in the relevant portion of the local electrical system to determine if available capacity exists to safely power a flexible load. When capacity exists the flexible load can be powered and when capacity is not available the flexible load can be disconnected to avoid an overcurrent event. In some applications, power to the flexible load is throttled to an intermediate level when there is less available capacity. Multiple EOMs powering flexible loads sharing the same electrical service may collectively follow a priority scheme to determine which flexible loads will be powered (and to what degree) under varying conditions. Coordination at the grid level can also be achieved to reduce the likelihood of a blackout or brownout event.

This application claims priority under 35 U.S.C. § 119(c) to U.S. provisional patent application, U.S. Ser. No. 63/440,123, filed Jan. 20, 2023, which is herein incorporated by reference in its entirety.

### BACKGROUND

The subject matter discussed in the background section should not be considered prior art merely because of its mention in the background section. Similarly, a problem mentioned in the background section or associated with the subject matter of the background section should not be considered to have been previously recognized in the prior art. The subject matter in the background section merely represents different approaches, which in and of themselves, may also correspond to claimed embodiments.

The advent of electric vehicles (EV) and increased electrification generally has the potential to significantly increase the electrical service demanded by residential and commercial buildings. In many cases the electrical service installed into such buildings does not have the capacity to service both the existing and new electrical loads resulting from electrification. Utilizing conventional approaches, building owners are faced with significant costs to upgrade electrical service to accommodate the additional electrical demand.

### SUMMARY

An energy orchestration module (EOM) is provided to dynamically power flexible loads such as electric vehicle batteries, water heaters, and heating ventilation and air conditioning (HVAC) systems. The EOM can monitor energy use in the relevant portion of the local electrical system to determine if available capacity exists to safely power a flexible load. When capacity exists the flexible load can be powered and when capacity is not available the flexible load can be disconnected to avoid an overcurrent event. In some applications, power to the flexible load is throttled to an intermediate level when there is less available capacity. Multiple EOMs powering flexible loads sharing the same electrical service may collectively follow a priority scheme to determine which flexible loads will be powered (and to what level they will be powered) under varying conditions. The priority scheme determines how available power capacity will be allocated among the flexible loads. Coordination at the grid level can also be achieved to reduce the likelihood of a blackout or brownout event.

One aspect relates to a system comprising an energy orchestration module (EOM). The EOM has (i) a sensor interface module to receive a real-time energy use rate measurement; (ii) an overcurrent protection mechanism to open and close an electrical path, the electrical path for delivering energy to a flexible load; and (iii) a low-voltage control circuit operably connected to (a) the sensor interface module to receive the energy use rate measurement and (b) to the overcurrent protection mechanism, the control circuit to control the overcurrent protection mechanism to maintain an energy use rate below a threshold based on the energy use rate measurement.

In some embodiments of the system, the control circuit further generates a control signal to maintain the energy use rate below the threshold based on the energy use rate measurement and the EOM further comprises a communications module to send the control signal to a load controller for the flexible load.

In some embodiments, the system further comprises an electrical panel connected to an energy supply wire that delivers energy into the electrical panel; a breaker having an input side and an output side; a current sensor to measure the energy use rate by measuring an electrical current through the energy supply wire, the current sensor operably connected to the sensor interface module; the electrical path; and the flexible load, wherein the control circuit operates on a lower voltage than that provided via the breaker; the breaker is electrically connected to the energy supply wire on the input side and to the overcurrent protection mechanism of the EOM on the output side; and the electrical path connects in sequence the energy supply wire, the breaker, the overcurrent protection mechanism, and the flexible load. In some embodiments, the breaker is a double pole breaker, and the overcurrent protection mechanism comprises two switches connected to respective poles of the breaker via the electrical path.

In some embodiments of the system, the flexible load is an electric HVAC (heating, ventilation and/or air-conditioning) system.

In some embodiments of the system, the EOM is a first EOM, the flexible load is a first flexible load, the breaker is a first breaker, the electrical path is a first electrical path, and the system further comprises a second EOM having a corresponding overcurrent protection mechanism and control circuit; a second flexible load; a second electrical path; and a second breaker; wherein the second flexible load is electrically connected to the second EOM by the second electrical path; and the first and second EOMs each have a respective communications module for communications therebetween, said communications to manage power delivery to the first and second flexible loads in accordance with a priority scheme while maintaining the energy use rate below the threshold.

In some embodiments of the system, the system further comprises a load controller for modulating power delivered to the flexible load, wherein, the EOM further comprises a communications module for sending a control signal to the load controller; and the control circuit generates the control signal to maintain the energy use rate below the threshold based on the energy use rate measurement at least in part by the control signal indicating to the load controller a maximum current the flexible load may draw. In some embodiments, if a difference between the threshold and the energy use rate measurement is less than a minimum current draw the load controller supports, the control circuit signals the overcurrent protection mechanism to open the electrical path.

In some embodiments of the system, the flexible load comprises an electric vehicle (EV) charging station. In some embodiments of the system, the flexible load is an electric water heater.

In some embodiments, the system further comprises a current sensor operably connected to the sensor interface module. In some embodiments of the system, the EOM further comprises a communications module to communicate with a load controller, the threshold is a first threshold, and the control circuit comprises at least one processor and at least one non-transitory computer-readable storage medium having stored thereon instructions which, when executed, program the at least one processor to perform a method comprising (i) receiving an energy use rate measurement from the current sensor via the sensor interface module; (ii) comparing the energy use rate measurement to the threshold; (iii) if the energy use rate exceeds the threshold, signaling the overcurrent protection mechanism to open the electrical path; and (iv) if the energy use rate measurement is less than the the threshold, signaling the overcurrent protection mechanism to close the electrical and sending a control signal via a communications module to a load controller indicating an available electrical capacity.

In some embodiments of the system, the current sensor is a first current sensor for taking first energy use rate measurements, the threshold is a first threshold, and the system further comprises a second current sensor for taking second energy use rate measurements, the second current sensor operably connected to the sensor interface module, wherein the control circuit controls the overcurrent protection mechanism to maintain the energy use rate below the first threshold and a second threshold based on the first and second energy use rate measurements, respectively.

In some embodiments, the system further comprises an electrical panel having a first current rating, the electrical panel connected to an energy supply wire that delivers energy into the electrical panel; a subpanel to the electrical panel having a second current rating; and a breaker within the subpanel electrically connected to the overcurrent protection mechanism, wherein the first and second current sensors are positioned to measure energy delivered into the electrical panel and the subpanel, respectively, and the first and second thresholds do not exceed the first and second current ratings, respectively. In some embodiments, the first and second thresholds are both between 70% and 90% of the first and second current ratings, respectively.

In some embodiments of the system, the EOM is a first EOM among a plurality of EOMs, each EOM comprising a communications module, and wherein the first EOM communicates to each other of the plurality of EOMs the energy use rate measurements via its communications module.

In some embodiments of the system, the plurality of EOMs control the power delivered to respective flexible loads in accordance with a priority scheme establishing an order of priority for the respective flexible loads and a maximum current draw for each of the respective flexible loads.

In some embodiments of the system, the EOM further includes a configuration interface to specify the threshold. In some embodiments, the configuration interface comprises a mechanical switch to specify the threshold. In some embodiments, the configuration interface comprises a software interface to specify the threshold.

Another aspect relates to a system comprising an energy orchestration module (EOM) having (i) a sensor interface module to receive a real-time energy use rate measurement; (ii) a low-voltage control circuit operably connected to the sensor interface module to receive the energy use rate measurement, the control circuit to generate a control signal to maintain an energy use rate below a threshold based on the energy use rate measurement; and (iii) a communications module for sending the control signal to a load controller for a flexible load.

In some embodiments, the system further comprises an overcurrent protection mechanism to open and close an electrical path, the electrical path for delivering energy to the flexible load, wherein the control circuit further controls the overcurrent protection circuit to close the electrical path if the control signal indicates the load controller should permit power delivery to the flexible load.

In some embodiments of the system, the control signal generated by the control circuit indicates an electrical current limit that the load controller is to enforce on the flexible load, and the electrical current limit when added to a portion of the energy use rate measurement that is not attributed to the flexible load, does not exceed the threshold.

In some embodiments, the system further comprises an electrical panel connected to an energy supply wire that delivers energy into the electrical panel; a breaker having an input side and an output side; a current sensor to measure the energy use rate by measuring an electrical current through the energy supply wire, the current sensor operably connected to the sensor interface module; the load controller; an electrical path; and the flexible load; wherein the control circuit operates on a lower voltage than that provided via the breaker; the breaker is electrically connected to the energy supply wire on the input side and to the load controller on the output side; and the electrical path connects in sequence the energy supply wire, the breaker, the load controller and the flexible load.

In some embodiments, the system further comprises an overcurrent protection mechanism connected to the electrical path between the first beaker and the flexible load, the over current protection mechanism to open and close the electrical path, wherein the control circuit further controls the overcurrent protection circuit to close the electrical path if the control signal indicates the load controller should permit power delivery to the flexible load.

In some embodiments of the system, the flexible load comprises an electric vehicle (EV) charging station.

In some embodiments of the system, the flexible load is an electric HVAC (heating, ventilation and/or air-conditioning) system.

Yet another aspect relates to a system for controlling a plurality of energy orchestration modules (EOMs) having a common primary energy source constraint, the system comprises at least one processor; and at least one non-transitory computer-readable storage medium having stored thereon instructions that, when executed, program the at least one processor to perform a method comprising (i) storing a maximum primary energy use rate for the primary energy source constraint; (ii) storing a plurality of maximum secondary energy use rates for a plurality of flexible loads, each secondary energy use rate for a respective flexible load and each flexible load having a respective EOM among the plurality of EOMs to control power delivery to the flexible load; (iii) receiving a primary energy use rate measurement; (iv) determining an available capacity based at least in part on the primary energy use rate measurement and the maximum primary energy use rate; (v) allocating at least a portion of the available capacity to at least one of the plurality of flexible loads in accordance with a priority scheme; and (vi) instructing the respective EOM for each of the at least one of the plurality of flexible loads to which the at least a portion of the available capacity has been allocated to permit power delivery to the flexible load in accordance with the allocating.

In some embodiments of the system, the plurality of flexible loads comprises at least two flexible loads capable of receiving modulated power and the respective EOMs for the at least two flexible loads capable of modulating power delivery; the allocating in accordance with the priority scheme comprises allocating the at least a portion of the available capacity to the at least two flexible loads such that each of the at least two flexible loads is to be powered at a same percentage of its respective maximum secondary energy use rate; and the instructing comprises transmitting control signals from the respective EOMs for the at least two EOMs to respective load controllers for the respective flexible loads, the control signals indicating respective amounts of modulated power delivery.

In some embodiments of the system, the priority scheme identifies a first priority flexible load as having a higher priority than a second priority flexible load, the first priority flexible load controlled by a first EOM and the second priority flexible load controlled by a second EOM; the allocating comprises allocating a first portion of the available capacity to the first priority flexible load and allocating a second portion of the available capacity to the second priority flexible load; and the instructing comprises instructing the first EOM to permit power delivery to the first priority flexible load at the maximum secondary energy use rate for the first priority flexible load and instructing the second EOM to permit power delivery to the second priority flexible load at a rate below the maximum secondary energy use rate for the second priority flexible load.

In some embodiments of the system, the priority scheme identifies a first priority flexible load as having a higher priority than a second priority flexible load, the first priority flexible load controlled by a first EOM and the second priority flexible load controlled by a second EOM; the allocating comprises allocating a first portion of the available capacity to the first priority flexible load and allocating a second portion of the available capacity to the second priority flexible load, and the instructing comprises instructing the first EOM to permit power delivery to the first priority flexible load at the maximum secondary energy use rate for the first priority flexible load and instructing the second EOM to permit power delivery to the second priority flexible load at the maximum secondary energy use rate for the second priority flexible load.

In some embodiments of the system, the priority scheme identifies a first priority flexible load as having a higher priority than a second priority flexible load, the first priority flexible load controlled by a first EOM and the second priority flexible load controlled by a second EOM; the second priority flexible load is not equipped to receive modulated power delivery; the allocating comprises allocating the portion of the available capacity to the first priority flexible load and determining a remaining portion of the available capacity is insufficient to fully power the second priority flexible load; and the instructing comprises instructing the first EOM to permit power delivery to the first priority flexible load at the maximum secondary energy use rate for the first priority flexible load and instructing the second EOM to prevent power delivery to the second priority flexible load.

In some embodiments of the system, the priority scheme identifies a first priority flexible load having priority over a second priority flexible load which itself has priority over a third priority flexible load, wherein the second priority flexible load is not equipped to receive modulated power delivery; the allocating comprises allocating a first portion of the available capacity to the first priority flexible load and allocating a second portion of the available capacity to a third priority flexible load; and the instructing comprises instructing the first EOM to permit power delivery to the first priority flexible load at the maximum secondary energy use rate for the first priority flexible load, instructing the second EOM to prevent power delivery to the second priority flexible load, and instructing the third EOM to permit power delivery to the third priority flexible load at a rate below the maximum secondary energy use rate for the third priority flexible load.

Still another aspect relates to an energy orchestration module (EOM) comprising (i) a sensor interface module to receive measurements of a first energy use rate; (ii) an overcurrent protection mechanism to open and close an electrical path, wherein the overcurrent protection mechanism, if closed, allows energy use by a flexible load connected to the electrical path at a second energy use rate; and (iii) a low-voltage control circuit comprising at least one processor and at least one non-transitory computer-readable storage medium having stored thereon instructions which, if executed, program the at least one processor to perform a method comprising acts of (i) determining the first energy use rate is below a maximum first energy use rate by at least a maximum second energy use rate; and (ii) in response to the determining, signaling the overcurrent protection mechanism to close the electrical path.

In some embodiments, the EOM further comprises a communications module, wherein the method performed by the control circuit further comprises acts of generating a control signal indicating the maximum second energy use rate; and transmitting the control signal via the communications module to a load controller.

In some embodiments of the EOM, the sensor interface module is connected to a first current sensor to measure the first energy use rate and to a second current sensor to measure the second energy use rate.

In some embodiments of the EOM, the maximum second energy use rate is a maximum among one or more maximum second energy use rates for which the determining holds truc.

In some embodiments of the EOM, the method performed by the control circuit further comprises an act of, if the first energy use rate is below the maximum first energy use rate by an amount less than the maximum second energy use rate, signaling the overcurrent protection mechanism to close the electrical path and to limit the second energy use rate to the amount.

In some embodiments of the EOM, the method performed by the control circuit further comprises acts of receiving over an internet connection information about energy availability from an electrical grid; and setting the maximum first energy use rate based at least in part upon the energy availability. In some embodiments, the energy availability indicates a peak event on the electrical grid, and setting the maximum first energy use rate comprises lowering the maximum first energy use rate relative to its value during a non-peak event.

Still a further aspect relates to a system comprising a server comprising at least one processor and at least one non-transitory computer-readable storage medium having stored thereon instructions which, when executed, program the at least one processor to perform a method comprising acts of (i) establishing a communications channel with each of a plurality of energy orchestration modules (EOMs); (ii) receiving, over the communications channels, location information from each of the plurality of EOMs; (iii) verifying based on the location information that the plurality of EOMs are operating from a common electrical transformer; and (iv) transmitting to each of the plurality of EOMs a respective maximum rate of energy consumption.

The foregoing is a non-limiting summary of the invention, which is defined by the attached claims.

### BRIEF DESCRIPTION OF DRAWINGS

The accompanying drawings are not intended to be drawn to scale. In the drawings, components that are illustrated in various figures that are the same or represent alternative embodiments of the same component are represented by like numeral. For purposes of clarity, not every component may be illustrated or labeled in every drawing. In the drawings:

FIG. 1 is a block diagram of an electrical system utilizing an energy orchestration module (EOM) to manage a flexible load, according to some embodiments;

FIG. 2 is a block diagram of a control circuit, according to some embodiments;

FIG. 3 is a flow diagram of a method for operating a flexible load, according to some embodiments;

FIG. 4 is a block diagram of a block diagram of an electrical system utilizing an EOM for a flexible load powered through a double pole breaker, according to some embodiments;

FIG. 5 is a block diagram of an electrical system utilizing an EOM and a load controller to manage a flexible load, according to some embodiments;

FIG. 6 is a block diagram of a load controller, according to some embodiments;

FIG. 7 is another block diagram of an electrical system utilizing an EOM and a load controller to manage a flexible load, according to some embodiments;

FIG. 8 is a block diagram of a method for operating a flexible load having a load controller, according to some embodiments;

FIG. 9 is block diagram of an electrical system utilizing an EOM to manage a flexible load powered off of a subpanel, according to some embodiments;

FIG. 10 is block diagram of an electrical system utilizing EOMs to manage flexible loads powered off of electrical panels connected in parallel to the electrical grid, according to some embodiments;

FIG. 11 is block diagram of an electrical system utilizing multiple EOMs to manage respective flexible loads, according to some embodiments;

FIG. 12 is another block diagram of an electrical system utilizing multiple EOMs to manage respective flexible loads powered by electrical panels and subpanels, according to some embodiments;

FIG. 13 is a flow diagram of a method for allocating power in accordance with a priority scheme, according to some embodiments;

FIG. 14 is a block diagram of an electrical system utilizing a central server to dictate, at least in part, management of flexible loads, according to some embodiments;

### DETAILED DESCRIPTION

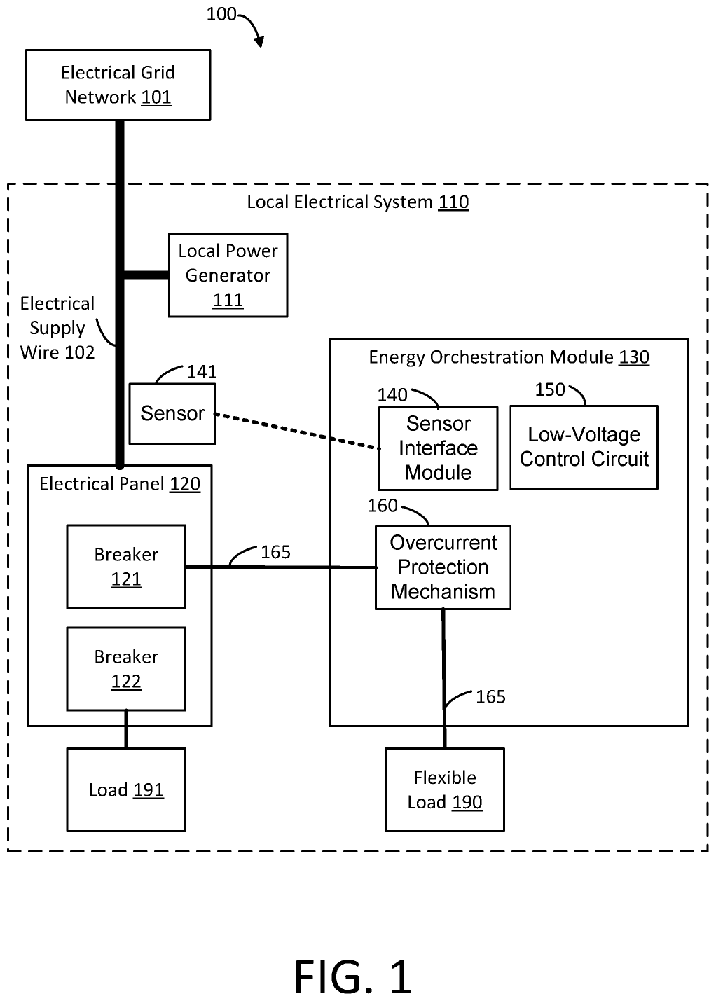

FIG. 1 is a block diagram of an electrical system 100, according to some embodiments. Electrical system 100 includes an electrical grid network 101 that connects to a local electrical system 110 via an electrical supply wire 102. Local electrical system 110 may be the local electrical system for a residential home, apartment building, commercial property, EV charging hub, or any terminal point to which loads are connected.

Local electrical system 110 includes an electrical panel 120 into which power is delivered via electrical supply wire 102. Electrical panel 120 includes one or more electrical circuit breakers such as breaker 121 which provides electricity to a flexible load 190 via energy orchestration module (EOM) 130.

In some embodiments, local electrical system 110 has a local power generator 111 such as a gas generator, solar panel system, or other system for electricity generation. Electricity generated by local power generator 111 may be made available to local electrical system 110, for example, via a line side tap or in any other suitable way. In some embodiments, local electrical system 110 is powered entirely by local power generator 111.

Flexible load 190 may be an electrical load that can be flexibly managed by an EOM. Some flexible loads may be capable of modulation; that is the maximum power draw expected from such a flexible load may be adjustable, fore example, over a range from 0 to 30 Amperes (or “Amps” or “A”). Flexible loads capable of modulation may include electric vehicle batteries, electric resistance water heaters, and other type of loads capable of operating under varying power constraints. Examples of flexible loads that may not be capable of modulation include lighting systems, heating ventilation and/or air conditioning (HVAC) systems and other loads that require access to their full power rating to operate properly. These examples are not categorical and any specific load type may or may not be capable of modulation in accordance with its design. Further examples of flexible loads include electric vehicle chargers, electric heat pumps, mini-splits, heat pump hot water heaters, resistive heat pumps, solar, home battery storage, electric vehicle battery storage; however, flexible loads are not so limited.

In some embodiments, electrical panel 120 has one or more bus bars, each bus bar providing power associated with a “pole” and providing a “hot” connection to the electrical grid via electrical supply wire 102. For example, in the United States it is common in residential buildings to have a “split-phase” (or “single-phase three wire”) connection to the electrical grid. In such a case there are two bus bars available. Electrical panel 120 may have any suitable number of breakers (e.g., breaker 121, breaker 122). Each breaker may be connected on an input side of the breaker to one or more bus bars depending on the properties of the load being served by that breaker. The output side of the breaker may be electrically connected, for example, to a load (e.g., breaker 122 connected to load 191). To illustrate, in the United States it is common to provide a 240V service to an electrical vehicle battery (an example of flexible load 1900, in which case breaker 121 would be required to be a double pole breaker connected on its input side to two poles in electrical panel 120 and electrically connected on its output side to overcurrent protection mechanism 160. It should be appreciated that embodiments may be adapted to both single-pole and multi-pole loads.

EOM 130 orchestrates management of electrical power consumption by flexible load 190 in the context of local electrical system 110. EOM 130 manages when and how much electrical power is delivered to flexible load 190. Energy orchestration management may be installed to provide overcurrent protection, for example, if flexible load 190 in combination with other loads (such as load 191 connected to breaker 122) and/or other flexible loads (not shown) is capable of consuming more electrical power than electrical panel 120 is rated to provide. For example, if flexible load 191 is capable of using 30 Amps, the sum of the other loads may reach 80 Amps, and electrical panel 120 is rated for 100 Amps, the panel rating is less than the total maximum load of 110 Amps. EOM 130 may thus be used to prevent the 100 Amp panel rating from being exceeded, allowing flexible load 190 be fully powered, for example, whenever all other loads account for less than 70 Amps. The inventors have recognized and appreciated that EOM 130 may be beneficially implemented in such circumstances in lieu of increasing the electrical service accessible to local electrical system 110. The inventors have further recognized and appreciated that circumstances where such an alternative may be desired will be in increased demand due to growing electrification in the United States and other countries.

EOM 130 may include a sensor interface module 140 through which sensor measurements may be received. For example, sensor 141 may be connected to sensor interface module 140. Sensor 141 may be connected to sensor interface module 140 in any suitable way (e.g., wired, wirelessly).

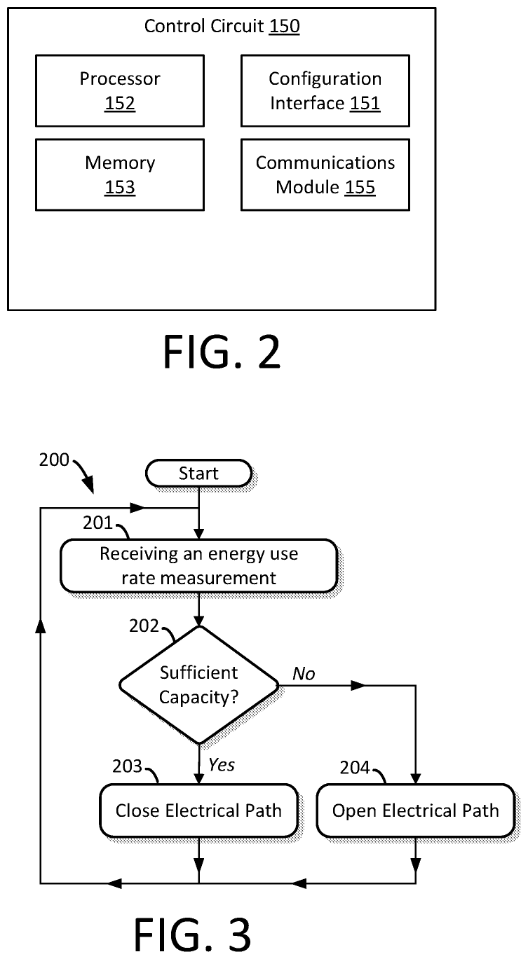

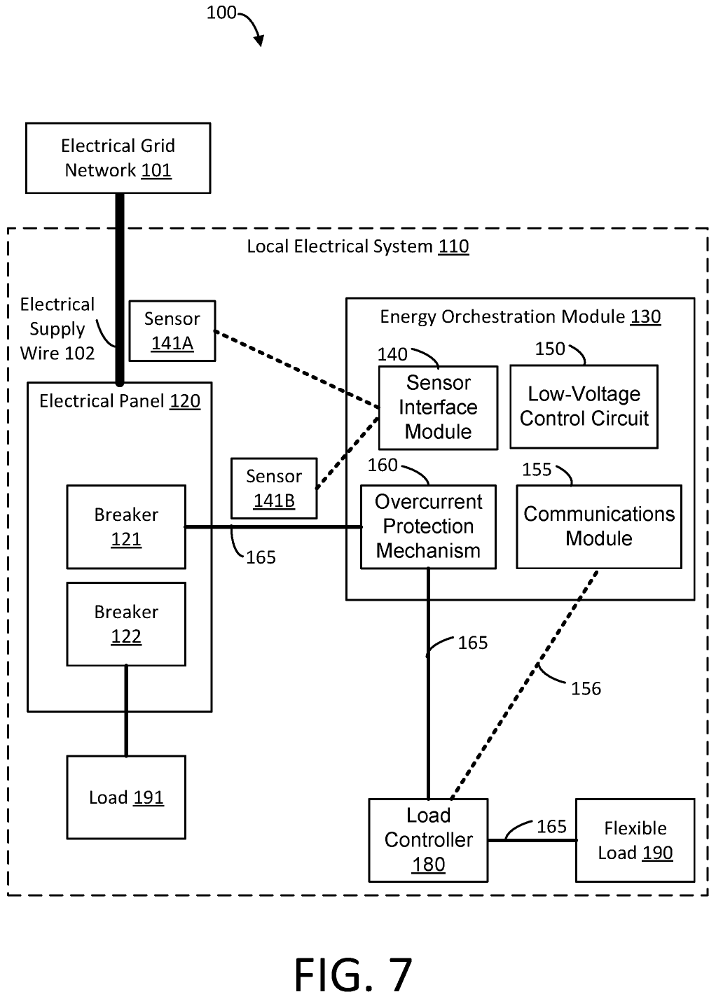

In some embodiments, sensor interface module 140 includes hardware to power sensor 141 and/or to digitize measurements from sensor 141. For example, sensor 141 may be a sensor that produces a voltage output that is proportional to the current into electrical panel 120 (i.e., proportional to the current in wire 102). Sensor interface module 140 may utilize an analog-to-digital converter (ADC) to convert the analog voltage measurement into a digital representation for use in further processing. In some other embodiments, sensor 141 provides a digital output and sensor interface module may simply provide an interface between sensor 141 and control circuit 150 for providing a sensor measurement for further processing in control circuit 150. In some embodiments, sensor 141 provides an output that is received through a communications module 155 of control circuit 150 (see FIG. 2) and sensor interface module 140 is a software interface that receives the sensor measurements and assigns them to variables for further analysis by other software code executed by control circuit 150. In some embodiments, sensor interface module 140 processes uses hardware and or software to process raw sensor measurements received from sensor 141 into a format that may used for further processing by control circuit 150. In some embodiments, sensor interface module 140 may receive sensor measurements from multiple sensors (see, e.g., FIGS. 7, 9, 10).

Sensor 141 may provide a real-time measure of the rate of energy use (power consumption). This measure may be presented in a power unit (e.g., Watts) or another unit (e.g., Amps) that is proportional to energy per unit time. In this disclosure, unless the context dictates otherwise, it is assumed that both power and electrical current are representative of an energy use rate. That is, it is assumed that the supplied voltage is constant. This is used both in the sense of direct current (DC) and alternating current (AC) applications. In the later, the voltage or current is said to be constant with respect to the RMS (root mean square) value. In applications where the supplied voltage is not constant (or it is insufficient to assume it is effectively constant) the rate of power consumption should be determined appropriately. For example, sensors may monitor both the voltage(s) and current(s) in the electrical supply wire such that the power may be calculated.

In some embodiments, sensor 141 may be an electrical current sensor such as a current transformer (CT), hall effect sensors, shunt resistors, Rogowski coils, or any other suitable sensor for inferring current draw. In some embodiments, sensor 141 may include multiple sensors such as voltage sensor(s) and current sensor(s) that may be used to determine an energy use rate (e.g., P=VI). Sensor 141 may include instrumentation for measuring and digitizing the sensor response. Though in some embodiments, sensor 141 simply provides an analog (e.g., voltage) output. In some embodiments, sensor 141 includes hardware for wired or wireless communication of such sensor response to the EOM 130. In such case, the wired or wireless communications capabilities of sensor 141 may be sufficient to communicate directly with EOM 130 or may communicate over the internet to a server where the sensor measurements can be utilized in connection with EOM 130.

EOM 130 may include a low-voltage control circuit 150 for performing various energy orchestration management functions. For example, control circuit 150 may determine if power should be delivered to flexible load 190, and if power is to be so delivered, cause an overcurrent protection mechanism 160 to close electrical path 165 allowing current to flow to flexible load 190. Similarly, if control circuit 150 determines power should not be delivered to flexible load 190 it may cause overcurrent protection mechanism 160 to open electrical path 165, preventing electrical current to flow to flexible load 190. Control circuit 150 may control, to the extent it is able, the overcurrent protection mechanism to maintain the energy use rate through electrical panel 120 below a threshold based on the energy use rate measurements by sensor 141. It is noted that control circuit 150 may be limited in the actions it can take to preventing power from being delivered to flexible load 190. Thus, control circuit 150 may not be able to prevent the energy use rate from exceeding the threshold if other aspects of local electrical system 110, such as excessive power consumption by load 191 or similar loads on electrical panel 120, cause the threshold to be exceeded regardless of whether flexible load 190 receives power.

Control circuit 150 may be “low-voltage” in the sense that the operating voltages of the components of control circuit 150 (other than e.g, power converters) are lower than the operating voltages of the electrical service provided via electrical supply wire 102. For example, control circuit 150 may operate at voltages commonly used for digital logic (e.g., 3.3 or 5 Volts DC) while the electrical supply wire may provide voltages of nominally 120 to 240 Volts AC RMS. In some embodiments, control circuit 150 operates on a DC voltage source of 3.3, 5, 10, 12, and/or 24 Volts. Though, any suitable set of operating voltage(s) may be used.

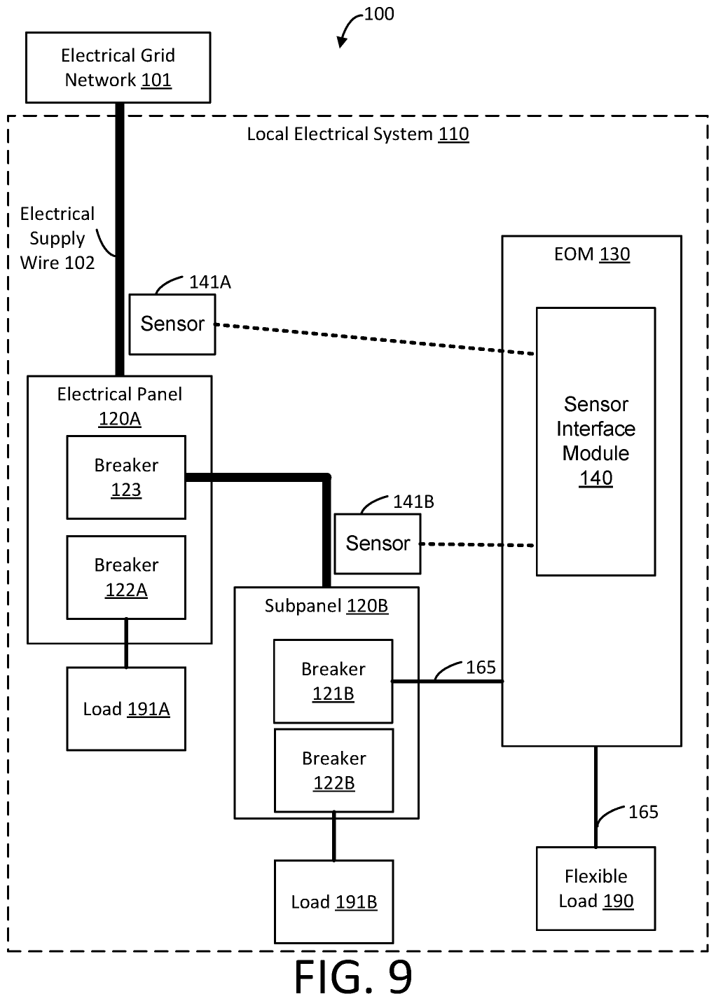

EOM 130 includes overcurrent protection mechanism 160 for protecting the operation of local electrical system 110 and power delivery to flexible load 190 from exceeding the electrical current limitations of local electrical system 110. In some embodiments, overcurrent protection mechanism 160 includes one or more actuators for opening and closing electrical path 165 over which flexible load 190 can receive electrical power provided by electrical grid network 101. In some embodiments, relays, contactors, circuit breakers, power amplifiers, or other electromechanical or thermoelectric hardware are used for switching. Though, any suitable switching mechanism may be used. Overcurrent protection mechanism 160 may have a relay for each pole of the electrical power being provided via breaker 121. In some embodiments, the actuators are controlled by low-voltage control circuit 150. In some embodiments, overcurrent protection mechanism 160 includes a set of actuators working with each other regardless of electrical hierarchy. Hierarchy may be defined as the degrees of separation between the EOM and the main electrical breaker. For instance, EOM 130 as shown in FIG. 1 is directly on a branch circuit of the main panel (electrical panel 120) and would be a “level 1” hierarchy. If an EOM were to be on a branch circuit of a sub panel off of the main panel, that would be a “level 2” hierarchy (see FIG. 9).

In some embodiments EOM 130 has a mechanism for determining if flexible load 190 is connected to electrical path 165. For example, if flexible load 190 is an EV it is expected that the EV will not always be connected to electrical path 165. In some embodiments, overcurrent protection mechanism 160 measures an electrical property or electrical response (e.g., impedance) on the portion of electrical path 165 going towards flexible load 190 to determine if flexible load 190 is present. Though, the presence of flexible load 190 on electrical path 165 may be determined in any suitable way.

FIG. 2 shows a block diagram of the low-voltage control circuit 150 according to some embodiments. In the illustrated embodiment, control circuit 150 includes a processor 152, memory 153, communications modules 155, and configuration interface 151. However, this is exemplary, and other embodiments of control circuit 150 may include other combinations of components.

Processor 152 may be any suitable processing device such as for example and not limitation, a central processing unit (CPU), digital signal processor (DSP), controller, addressable controller, general or special purpose microprocessor, microcontroller, addressable microprocessor, programmable processor, programmable controller, dedicated processor, dedicated controller, or any suitable processing device. In some embodiments, processor 152 comprises one or more processors, for example, processor 152 may have multiple cores and/or be comprised of multiple microchips. As discussed further below, processor 152 may be configured to implement various algorithms implemented in software, hardware, or a combination thereof and may be operably connected to other components of control circuit 150, EOM 130, or other parts of system 100. Processor 152 may perform such algorithms sequentially, in parallel, or by some other method or combination of methods.

Memory 153 is a non-transitory computer-readable storage media that may be integrated into processor 152 and/or may include “off-chip” memory that may be accessible to processor 152, for example, via a memory bus (not shown). Memory 153 may store software modules that when executed by processor 152 perform desired functions. These functions may interact with the other components of EOM 130 and more broadly system 100 electrically, mechanically, or in other suitable ways or combination of ways. Memory 153 may be any suitable type of non-transitory computer-readable storage medium such as, for example and not limitation, RAM, a nanotechnology-based memory, optical disks, volatile and non-volatile memory devices, magnetic tapes, flash memories, hard disk drive, circuit configurations in Field Programmable Gate Arrays (FPGA), or other semiconductor devices, or other tangible, non-transitory computer storage medium.

EOM 130 may have functional modules to perform specific functions such as processing data, analyzing data, controlling other local or remote components or devices, communicating information to other local or remote components or devices, and other types of operations that may be computer controlled. Communications module 155, is one such functional module for communicating with components outside of EOM 130. Communications module 155 may be any suitable combination of hardware and software configured to communicate with other devices. In some embodiments, communications module 155 is adapted for direct communication or for communication over a network. For example, communications module 155 may be implemented as a network interface driver and a network interface controller (NIC). The network interface driver may be configured to receive instructions from other components of EOM 130 to perform operations with the NIC. The NIC provides a wired and/or wireless connection the network. The NIC is configured to generate and receive signals for communication over the network. In some embodiments, communications module 155 may support a custom communication protocol or one or more communications standards or technologies (e.g., Ethernet, Wi-Fi, ZigBee, TCP/IP). In some embodiments communications module 155 provides internet connectivity to EOM 130. In some embodiments, communications module 155 provides wired or wireless communications with the home's electrical infrastructure, such as a main electrical panel, sub panel, critical loads panel, and other smart devices, to exchange information with such devices.

Configuration interface 151 provides a user interface for configuration of EOM 130. Configuration parameters may include the capacity of electrical panel 120, capacity of breaker 121, user priorities, and other parameters that may be utilized by EOM 130 for operation. In one embodiment, configuration interface 151 is one or more DIP switches read by control circuit 150 and used to specify capacity or a usage rate threshold. In another embodiment, configuration interface 151 is a user interface viewed by a user on a display. For example, configuration interface 151 may be accessed over a wired or wireless connection in an app or a web browser to permit a user to specify configuration parameters. Other configuration interface 151 embodiments may include any suitable combination of hardware and software for allowing a user to specify configuration parameters. In some embodiments, configuration interface 151 may allow configuration parameters to be specified at least in part through an application programming interface (API). Configuration parameters may be pulled from a server accessible from the internet—for example, current electricity rates may be accessed over the internet and utilized by EOM 130 to determine if flexible load 190 should be charged at a particular time.

Attention is now turned to FIG. 3 which shows a flow diagram of a method 200 for operating a flexible load. Method 200 may be executed by a single EOM, executed by a group of EOMs, executed by a separate computer or computers locally in communication with the EOM(s), executed by a separate computer or computers in communication with the EOM(s) over the internet (or other network), or in any other suitable way or combination of ways. Method 200 may be implemented using any suitable combination of hardware and software. In some embodiments, method 200 is implemented by EOM 130 discussed in connection with FIG. 1.

At step 201 of method 200 an energy use rate measurement is received. Such a use rate may be received, for example, from a sensor that measures an energy use rate in the system in which a flexible load is operating. To illustrate an embodiment with reference to system 100 in FIG. 1, sensor interface module 140 of EOM 130 may receive an energy use rate measurement from sensor 141. In some embodiments, multiple energy use rate measurements are received; each measurement may correspond to a sensor measuring a different aspect of the system 100. Further discussion of energy use rate measurements are found throughout the specification.

At step 202, method 200 determines whether sufficient capacity exists to power flexible load 190. This determination may be made, for example, by evaluating the energy use rate measurement(s) and determining if any energy use rate would exceed a corresponding threshold if flexible load 190 were to be powered and reaching an affirmative (“Yes”) determination if no threshold would be exceeded, and a negative (“No”) determination otherwise. To illustrate an embodiment with reference to system 100 in FIG. 1, control circuit 150 of EOM 130 may store the applicable thresholds as configuration parameters in memory. The capacity needed to power flexible load 190 may also be stored as a configuration parameter. For example, the threshold corresponding to sensor 141 may be based on the current rating of electrical panel 120 (e.g., 70%, 80%, 90%, 100% of the current rating). Similarly, the capacity needed to power flexible load 190 may be the current rating of breaker 121. Though this is just an example, and other embodiments may utilize different criteria.

If an affirmative determination is made at step 202, method 200 proceeds to step 203 and closes the electrical path allowing current to flow to the flexible load. In the example of EOM 130 shown in FIG. 1, control circuit 150 may signal overcurrent protection mechanism 160 to close electrical path 165. It should be appreciated that if the electrical path is already closed when step 203 is to be performed, step 203 takes only that action (if any) needed to maintain the electrical path in the correct state.

If a negative determination is made at step 202, method 200 proceeds to step 204 and opens the electrical path preventing current from flowing to the flexible load. In the example of EOM 130 shown in FIG. 1, control circuit 150 may signal overcurrent protection mechanism 160 to open electrical path 165. It should be appreciated that if the electrical path is already open when step 203 is to be performed, step 203 takes only that action (if any) needed to maintain the electrical path in the correct state.

After steps 203 and 204 method 200 returns to step 201 and the method may continue indefinitely.

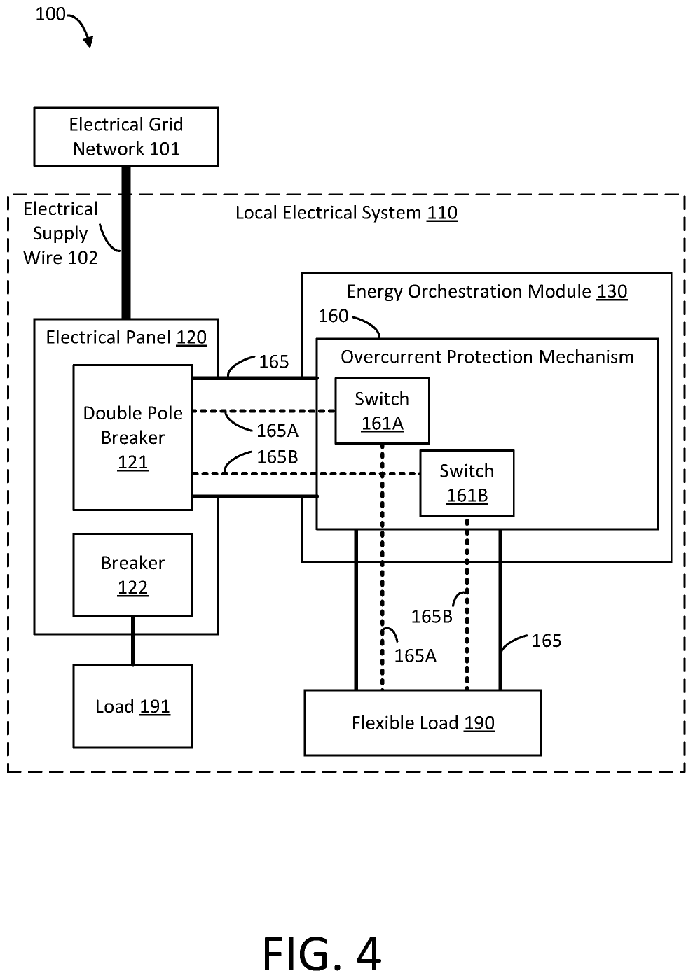

FIG. 4 shows another embodiment of system 100. For simplicity, several aspects of system 100 are not shown to focus the conversation on the differences with FIG. 1. In this illustration, flexible load 190 is capable of utilizing double pole power and thus, breaker 121 is a double pole breaker. Electrical path 165 has a first hot wire 165A associated with one pole and a second hot wire 165B associated with a second pole. (Additional wires such as for neutral and ground may also be present but for simplicity are not illustrated.) Overcurrent protection mechanism 160 includes a switch 161A for opening and closing the electrical path 165A and a switch 161B for opening and closing the electrical path 165B. During operation, EOM 130 may determine that flexible load 190 is not to be powered; accordingly, switches 161A and 161B are opened to prevent the flow of electricity along electrical path 165. During operation, EOM 130 may determine that flexible load 190 is to be powered; accordingly, switches 161A and 161B are closed to allow the flow of electricity along electrical path 165. During operation, EOM 130 may determine that flexible load 190 is to be powered via a single pole of the electrical service; accordingly, one of switches 161A and 161B is opened and the other is closed to limit the electrical power available to flexible load 190. The determination of the state of switches 161A and 161B may be made in ways similar to those discussed in connection with, for example, method 200 (FIG. 3).

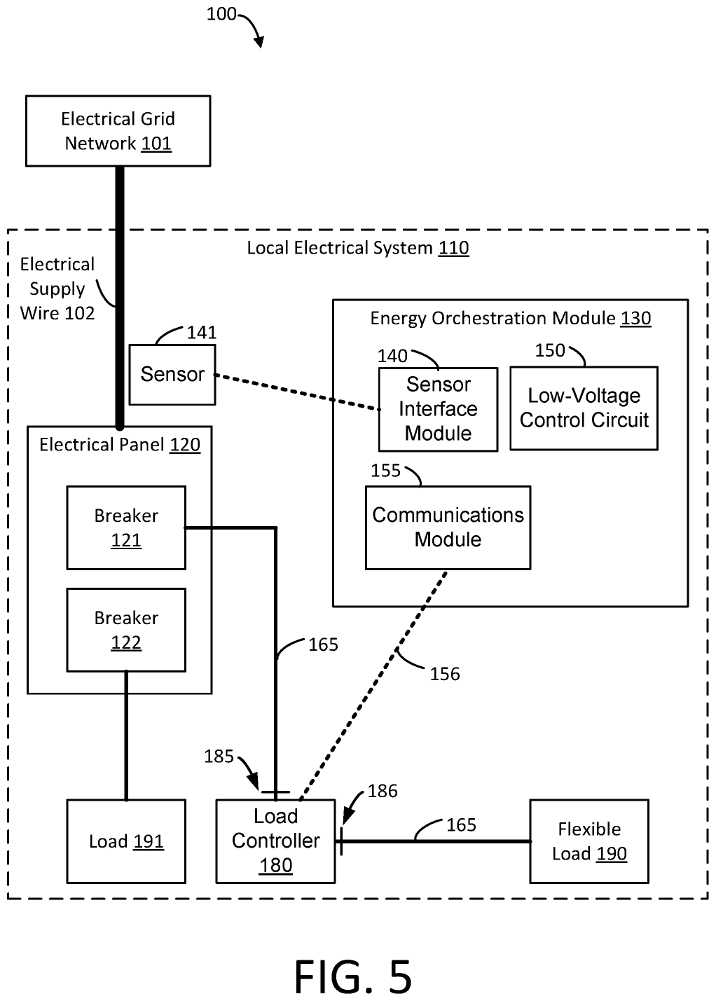

Turning to FIG. 5, another embodiment of system 100 is discussed. In the illustrated embodiment, flexible load 190 has a load controller 180 that controls current flow to flexible load 190. In some embodiments load controller 180 is part of an EV charging station or as part of an EV, though load controller 180 may be implemented in any suitable way. EOM 130 utilizes communications module 155 to send control signals to load controller 180 via communications channel 156. Electrical path 165 is input into load controller at port 185 and exits load controller 180 at port 186. In some embodiments, load controller 180 has the ability to open and close electrical path 165. In some embodiments, load controller 180 has the ability to limit power to flexible load 190 to a set of discrete power levels or a range of power levels. The control signals may provide instructions to load control 180 that are used to maintain the energy use rate through electrical panel 120 below the threshold based on the energy use rate measurements obtained by sensor 141. For example, the control signal may indicate a maximum current flexible load 190 may draw via electrical path 165. As with the embodiment of system 100 discussed in connection with FIG. 1, EOM 130 may only be able to control energy use by flexible load 190 which may be insufficient to prevent overcurrent events in panel 120.

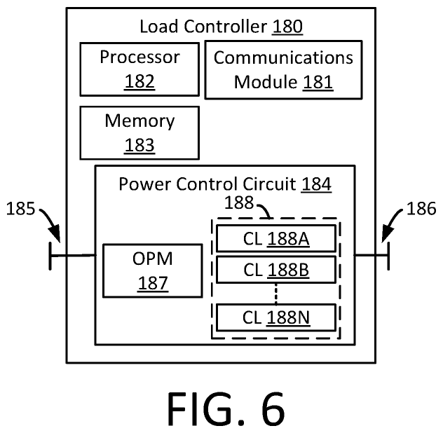

FIG. 6 shows an example embodiment of load controller 180. Load controller 180 has memory 183, processor 182, and communications module 181, each of which may be implemented in ways similar to those discussed in connection with memory 153, processor 152, and communications module 155, respectively, of control circuit 150 in connection with FIG. 2, or in any suitable way. Communications module 181 may be utilized to receive the control signals from communications module 155 of EOM 130. Additionally, load controller 180 may have a power control circuit 184 that implements various power delivery constraints. In some embodiments, power control circuit 184 includes an overcurrent protection mechanism (OPM) 187 that is capable of opening or closing electrical path 165. Overcurrent protection mechanism 187 may be similar to overcurrent protection mechanism 160 discussed, for example, in connection wth FIG. 1. In some embodiments, power control circuit 184 includes a current limiter 188. Current limiter 188 may limit the electrical current flowing through electrical path 165 to a particular amount. For example, power control circuit 184 may include three discrete current limiters 188A, 188B, and 188N having respective current limits of 5, 10 and 20 Amps. Communications module 155 of EOM 130 may send a control signal to load controller 180 selecting which current limiter should be utilized at a particular time and power control circuit 184 may be configured accordingly, for example, using software residing on memory 183 and executed by processor 182. Though, current limiter 188 may be configured in any suitable way. If the control signal indicates, for example, that the current should be limited to 5 Amps, the electrical path 165 is directed through current limiter 188A. Similarly, the electrical path 165 may be adjusted if the control signal indicates the 10 or 20 Amp current limiter should be utilized. In some embodiments, the control signal may require current limiters to be utilized in parallel. For example, the electrical path 165 may pass through both the 10 and 20 Amp current limiters, effectively permitting a maximum current of 30 Amps. Current limiters 188 may be implemented in any suitable way. In some embodiments, current limiter 188 consists of a set of discrete current limits while in some other embodiments current limiter 188 is continuously adjustable to any practical current limit. In some embodiments, EOM 130 prevents a control signal from being sent to load controller 180 setting current limiter 188 to a limit that would exceed the capacity of breaker 121 and/or electrical panel 120.

Returning to FIG. 5 it is noted that in this embodiment of electrical system 100, electrical path 165 does not pass through EOM 130. Accordingly, more flexibility exists in the location and structure of EOM 130. In some embodiments, physical hardware is installed on premises within the local electrical system 110 as illustrated in FIG. 5. In another embodiment however, EOM 130 may be remote with measurements from sensor 141 received over a wired or wireless connection and control signals sent via communications channel 156. For example, EOM 130 could be on a server on the internet and the communications to and from EOM 130, sensor 141, and load controller 180 could be over the internet.

In some embodiments, EOM 130 has a mechanism for determining if flexible load 190 is connected to electrical path 165. For example, if flexible load 190 is an EV it is expected that the EV will not always be connected to electrical path 165. In some embodiments, communications channel 156 is a bidirectional channel and load controller 180 detects whether flexible load 190 is connected and sends a signal to EOM 130 over communications channel 156 indicating whether flexible load 190 is present. Though, the presence of flexible load 190 on electrical path 165 may be determined in any suitable way. Further, communications channel 156 may be utilized to communicate information about flexible load 190 to EOM 130 that may be used to determine if and when to power flexible load 190 and, if appropriate, how to modulate the provided power. For example, if flexible load 190 is a battery, communicating the charge level and/or and indication of the amount of energy needed to fully charge the battery may be utilized as part of a priority scheme as discussed further herein.

FIG. 7 shows an embodiment of electrical system 100 where EOM 130 includes aspects of both the embodiment shown and discussed in connection with FIG. 1 and that shown and discussed in connection with FIG. 5. In this example, control circuit 150 may utilize both overcurrent protection mechanism 160 and instructing load controller 180 to control power delivery to flexible load 190. In the illustrated embodiment local electrical system 110 includes two sensors, namely, sensor 141A to measure the energy use rate of the electrical panel 120 and sensor 141B to measure the energy use rate along the electrical path. Both measurements may be received by EOM 130, for example, via sensor interface module 140. Control circuit 155 may utilize the energy use rate measurements from both sensor in performing its control functions. In some embodiments, sensor 141B may be omitted.

In some embodiments, load controller 180 does not directly control electrical path 165 and is used solely to exchange information with EOM 130. In some embodiments, load controller 180 receives information about the state of the home's electrical capacity through EOM 130 and can make optimization decisions based thereon. For example, the flexible load may configure itself to operate in a way that requires less power consumption based on real-time limitations of the electrical system communicated by EOM 130 to flexible load 190 over the communications channel 156.

In FIGS. 1, 4, 5 and 7, EOM 130 has been illustrated as a separate part of local electrical system 110. In this illustrated embodiment, EOM 130 may include one or more housings for the components of the EOM. The housing may be secured, for example to a surface adjacent to electrical panel 120 or at another location. It should be appreciated that EOM 130 may be implemented in other ways than those expressly illustrated. In some embodiments EOM 130 is integrated into electrical panel 120. In some other embodiments, EOM 130 is integrated into load controller 180 or flexible load 190. Further, in some embodiments EOM 130 may be implemented completely or partially on a remote server (in the “cloud”). In some embodiments, processing associated with the EOMs may utilize an edge computing architecture. In some embodiments, each EOM is a discrete unit that wired or wirelessly communicates with other EOMs. Such EOMs may be in discrete enclosures, embedded within the electrical panel(s), external to the electrical panel(s), adjacent to the flexible loads, or integrated into the flexible loads.

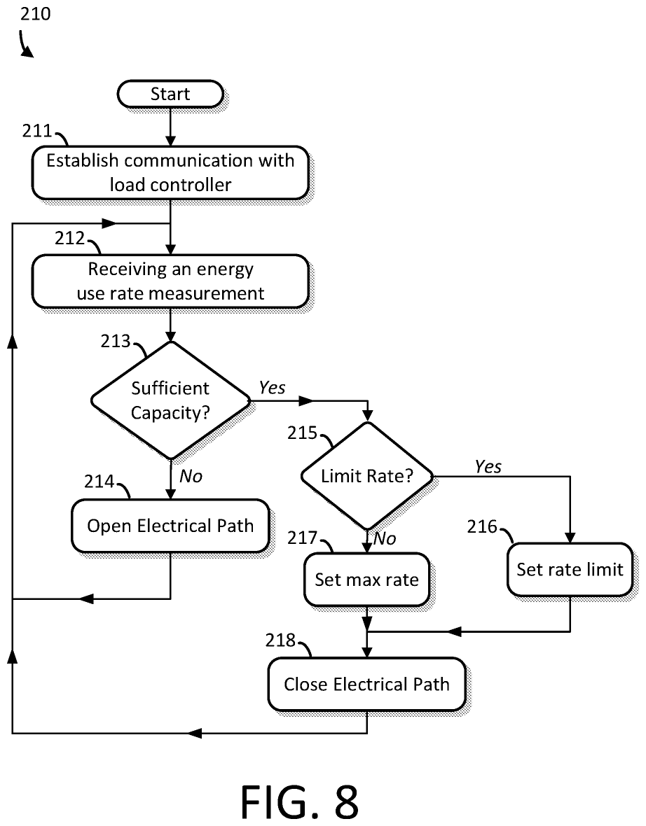

FIG. 8 shows a flow diagram of a method 210 for operating a flexible load having a load controller. Method 210 may be executed by a single EOM, executed by a group of EOMs, executed by a separate computer or computers locally in communication with the EOM(s), executed by a separate computer or computers in communication with the EOM(s) over the internet (or other network), or in any other suitable way or combination of ways. Method 210 may be implemented using any suitable combination of hardware and software. In some embodiments, method 210 is implemented by EOM 130 discussed in connection with FIG. 7.

At step 211 of method 210 communication is established or verified with a load controller. As part of this step, the load controller may provide information about its capabilities over the communications channel. For example, the load controller may indicate a discrete set of current limiters that may be enabled or disabled to restrict the power consumption of flexible load capable of modulation. The load controller may also verify that a flexible load is connected to the load controller and that the flexible load itself can be modulated in accordance with such current limiters. To illustrate an example embodiment with reference to system 100 in FIG. 7, load controller 180 may communicate such information with EOM 130 via communications channel 156. In some embodiments step 211 may be unnecessary, for example, if the EOM is an integral part of the load controller or if the EOM is preprogrammed with such information. While step 211 is illustrated as a preliminary step in method 210, it should be appreciated that the step may be performed on a regular or continuous basis (e.g., using an interrupt) to verify continued connectivity between the EOM, load controller and/or flexible load.

At step 212 of method 210 an energy use rate measurement is received. Such a use rate may be received, for example, from a sensor that measures an energy use rate in the system in which the flexible load is operating. To illustrate an embodiment with reference to system 100 in FIG. 7, sensor interface module 140 of EOM 130 may receive an energy use rate measurement from sensor 141. In some embodiments, multiple energy use rate measurements are received; each measurement may correspond to a sensor measuring a different aspect of the system 100.

At step 213, method 210 determines whether sufficient capacity exists to power flexible load 190. This determination may be made, for example, by evaluating the energy use rate measurement(s) and determining if any energy use rate would exceed a corresponding threshold if flexible load 190 were to be minimally powered and reaching an affirmative (“Yes”) determination if no threshold would be exceeded, and a negative (“No”) determination otherwise. To illustrate an embodiment with reference to system 100 in FIG. 7, control circuit 150 of EOM 130 may store the applicable thresholds as configuration parameters in memory. The minimum and maximum capacity needed to power flexible load 190 may also be stored as a configuration parameter. For example, the threshold corresponding to sensor 141 may be based on the current rating of electrical panel 120 (e.g., 70%, 80%, 90%, 100% of the current rating). Similarly, the maximum capacity needed to power flexible load 190 may be rating of breaker 121. A minimum capacity needed to power flexible load 190 may be a minimum current level setting of load controller 180.

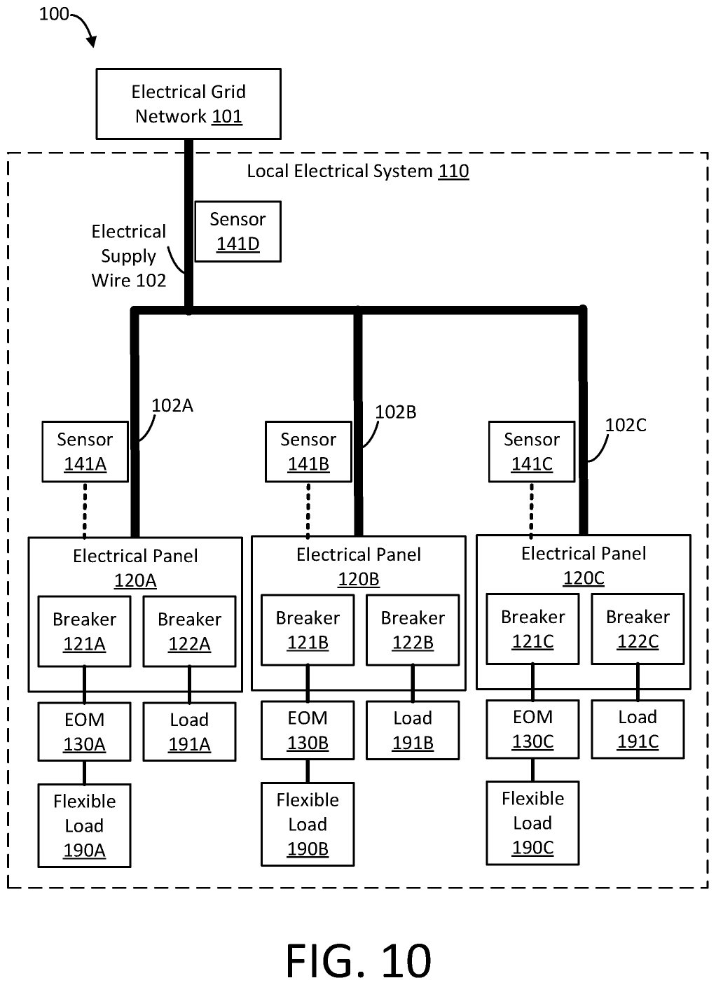

In some embodiments, determining whether sufficient capacity exists to power flexible load 190 involves satisfying one or more inequalities. If all inequalities are satisfied sufficient capacity exists, otherwise it does not. Each capacity constraint may be expressed by an inequality. In FIGS. 1, 4, 5 and 7 a single capacity constraint is illustrated—namely the constraint on the amount of power flowing through electrical panel 120. In some of the subsequent figures, such as FIG. 9 and FIG. 10, multiple capacity constraints may need to be satisfied to ensure sufficient capacity. Capacity constraints may be expressed as:

[sensed power]<[threshold power]−[flexible load power]

where sensed power is the measured energy use rate applicable to the constraint, threshold power is the maximum permissible power consumption at the capacity constraint, and flexible load power is the power to be consumed by the flexible load. Sensed power may be measured by a single sensor or, for example and as discussed in connection with FIG. 10, may be a sum of sensor measurements based on conservation principles. Flexible load power, for the purposes of method 210 may be the minimum rate of power use by a flexible load cable of modulation. (It is noted that in the case where the flexible load cannot be modulated method 210 effectively simplifies to method 200.)

It should be appreciated that whether sufficient capacity exists could also be determined in other ways. For example, the above could be broken down into a first step of determining if there is available capacity:

[available capacity]=[threshold power]−[sensed power]

If there is not any available capacity, method 210 may proceed directly to step 214. If there is available capacity it can then be determine if available capacity is sufficient:

[flexible load power]<[available capacity]

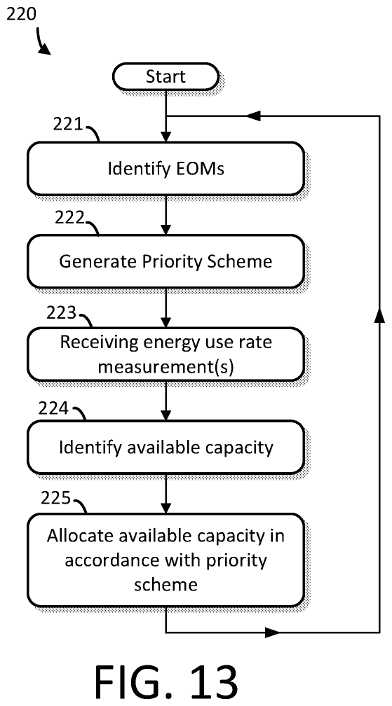

(This approach may also be useful when multiple flexible load powers are to be tested against an available capacity in implementing a priority scheme as further discussed, for example, in connection with FIG. 13.)

As a numerical example of step 213, assume the method is implemented in system 100 as shown in FIG. 7. Assume electrical panel 120 is rated for 100 Amps, breaker 121 is rated for 30 Amps and the threshold energy usage rate for the electrical panel is 80% capacity. Further assume flexible load 180 is capable of current limiting to 6 Amps, 10 Amps, 20 Amps and 30 Amps. Thus the threshold power is 80 Amps (80% of 100 Amps) and the flexible load power is the lowest flexible load power (6 Amps). Assume that sensor 141A measures 65 Amps. Thus the capacity inequality (65<80−6) is determined to be true. Accordingly, under this example, capacity is determined to be available (“Yes”) and method 210 continues to step 215.

If at step 213 it is determined that sufficient capacity does not exist (“No”), method 210 proceeds to step 214 where the flexible load is electrically disconnected by opening the electrical path. For example, and with reference to FIG. 7, overcurrent protection mechanism 160 may open electrical path 165 an in implementation of this step 214. Alternatively or additionally, if load controller 180 itself has a zero current mode, communications module 155 may instruct load controller 180 to enter such mode. In the embodiment of system 100 shown in FIG. 5 control circuit 150 may send a control signal via communications channel 156 that causes load controller 180 to open electrical path 165. It is noted that if load controller 180 does not have the capability to limit power delivery to flexible load 190 to zero, local electrical system 110 should be designed to ensure step 214 is never reached and that sufficient capacity should always exist to power flexible load 190 at the lowest power level permitted by load controller 180.

If at step 213 it is determined that sufficient capacity does exist (“Yes”), method 210 proceeds to step 215 where method 210 determines whether the energy use rate of flexible load needs to be limited. Here the available capacity is compared to the maximum usage rate of the load. If the maximum usage rate of the load is less than the available capacity, the rate need not be limited and method 210 proceeds to step 217 (“No”). If the maximum usage rate of the load is greater than the available capacity, the rate needs to be limited and the method 210 proceeds to step 216 (“Yes”). In some embodiments, the maximum energy usage rate of the load is taken to be the rating of the breaker to which the flexible load is connected. In some embodiments, the maximum energy usage rate is taken as the maximum current supported by the associated load controller. Though, the maximum energy usage rate may be determined in any suitable way.

Continuing the above example with reference to FIG. 7, the applicable inequality is

65<80−30

which is false and thus the example continues to step 216.

If at step 215 it is determined that energy usage rate needs to be limited (“Yes”), method 210 proceeds to step 216. At step 216 a control signal is sent to the load controller indicating the appropriate rate limit. The appropriate rate limit may be selected in any suitable way. For example, the appropriate rate limit may be selected as the maximum available limited rate that does not exceed the available capacity. Though, it should be appreciated that in some other embodiments, a lower rate limit may be selected based, for example, on other considerations in the applicable priority scheme.

Continuing the above numerical example which referenced FIG. 7, the appropriate capacity limit can be determined, for example, by sequentially testing each of the available power limits and choosing the highest available power limited rate that does not exceed the available capacity. Accordingly, a control signal may be sent to the load controller indicating the 10 Amp limit should be used.

If at step 215 it is determined that energy usage rate does not need to be limited (“No”), method 210 proceeds to step 217 where a control signal is sent to the load controller indicating that the rate need not be restricted to a limit lower than the maximum current rating of the flexible load.

After setting the rate limit at step 216 or indicating that the rate need not be restricted to a limit lower than the maximum current rating of the flexible load at step 217, method 210 proceeds to step 218. At step 218 the electrical path is closed allowing the flexible load to be powered at the appropriate rate.

After completion of step 214 or step 218, method 210 returns to step 212 and repeats. It should be appreciated that step 214 and step 218 may not require any action if the state of the electrical path is unchanged. Similarly, a control signal need not be sent at steps 216 and 217 if the load controller is already limiting the energy usage rate to the appropriate limit.

FIG. 9 shows an embodiment of electrical system 100 where EOM 130 manages a flexible load 190 receiving power from a subpanel 120B, which itself is connected to a main electrical panel 120A. More specifically, electrical path 165 connects flexible load 190 to breaker 121B of subpanel 120B. While electrical path 165 is shown through EOM 130, it should be appreciated that other embodiments are possible, such as one similar to that shown in FIG. 5. Subpanel 120B is power via breaker 123 of electrical panel 120A. Both electrical panel 120A and electrical panel 120B may have additional loads. For example, load 191A is powered via breaker 122A of electrical panel 120A, and load 191B is powered via breaker 122B of subpanel 120B. In the illustrated embodiment, local electrical system 110 includes sensor 141A for measuring the energy use rate of electrical panel 120A and sensor 141B for measuring the energy use rate of electrical panel 120B. Both sensor measurements are received by sensor interface module 140 of EOM 130. In powering flexible load 190, control circuit 155 may consider both the capacity of subpanel 120B (a “level 1” constraint) and electrical panel 120A (a “level 2” constraint). Flexible load 190 is powered such that neither capacity is exceeded. This may be determined by evaluating appropriate inequalities associated with each level constraint and only permitting powering of the load if sufficient capacity exists at all hierarchical levels. While a breakout into a main panel (electrical panel 120A) and a single subpanel (subpanel 120B) is illustrated, it should be appreciated that subpanels may themselves have subpanels and so on as may be used in practical applications.

Consider an example of operation of system 100 shown in FIG. 9. In this example, assume flexible load 190 is an EV connected via an EV charger (a type of load controller). EOM 130 stores the maximum current settings for electrical panel 120A, subpanel 120B, and the EV charger. These setting may be specified, for example, through the configuration interface of EOM 130 (e.g., physical like dip switches or digital interfaces like an electrician app). The real-time current measurement for panels 120A and 120B are obtained by EOM 130 from sensors 141A and 141B. EOM 130 performs calculations to determine the available capacity and allocate it to the EV as appropriate. The calculations include (1) determining the available capacity of electrical panel 120A and the subpanel 120B, each of which may be calculated, for example, as:

[available capacity]=([electrical panel rating]×[threshold percentage])−[real-time current draw]

The smallest of (1) the available capacity of electrical panel 120A, (2) the available capacity of subpanel 120B and (3) the max rate of the EV charger is selected. This rate may be communicated to the EV charger if it is the max rate of the EV charger or if the EV charger offers continuous modulation, or if the EV charger is capable of selecting a modulation level based on the max available rate (e.g, selecting the appropriate current limiter(s) to maximize charging rate while not exceeding the specified rate). Alternatively, the EOM may select the current limiter(s) to be enabled in the EV charger and communicate the same to the EV charger. If a communications channel does not exist to the EV charger or if the EV charger does not support modulation, an overcurrent protection mechanism in EOM 130 may be used to open electrical path 165 if the max available rate is less than the max available rate of the EV charger or close electrical path 165 if the max available rate is greater than or equal to the max available rate of the EV charger. Where communication with the EV charger exists it may be practical to modulate the electric power in real-time.

FIG. 10 shows another embodiment of electrical system 100 where there are multiple electrical panels (electrical panels 120A, 120B, and 120C) connected in parallel to one another. Each panel may have a breaker (breakers 121A, 121B and 121C) connecting an EOM (EOMs 130A, 130B, and 130C) to a respective flexible load (flexible loads 190A, 190B and 190C) as well as other breakers (breakers 122A, 122B and 122C) connected to other loads (loads 191A, 191B and 191C). While a breakout into three panels is illustrated, it should be appreciated that any number of parallel panels (e.g, 2, 3, 4, 5, 6, . . . ) may be used in practical applications.

EOM 130A is capacity restrained by the service limitations of electrical panel 120A (hierarchical level 1) as well as the capacity constraint on the total electrical power entering the local electrical system through wire 102 (hierarchical level 2). EOM 130A may receive a measure of power into electrical panel 120A via sensor 141A. Sensor 141A may, for example, measure the current in wire 102A. EOM 130 may receive a measure of power through wire 120 via sensor 141D. Alternatively, the current in electrical supply wire 102 could be determined by adding the current measurements in wires 102A, 120B, and 102 as measured by sensors 141A, 141B, and 141C, respectively (relying on the conservation principle known as Kirchoff's current law). For simplicity, connectivity with sensor 141D and each of the electrical panels is not illustrated though any suitable mechanism for utilizing the sensor measurement as part of the capacity determination may be used.

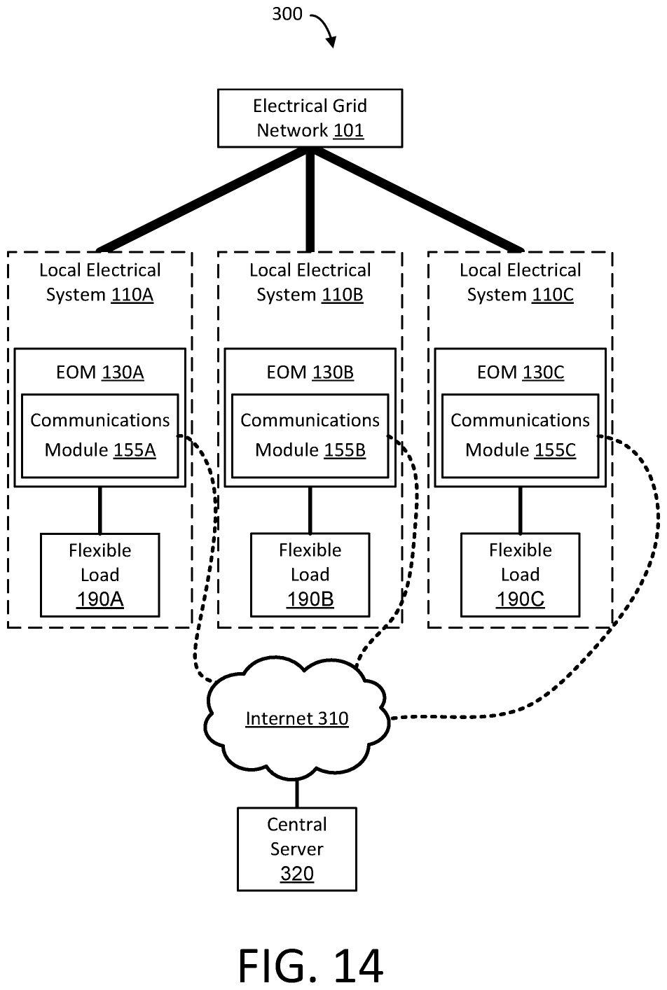

Whether to utilize current sensors on each parallel electrical panel and sum the results or to instrument the main supply wire may depend on the implementation details. If not all electrical panels have a dependent EOM it may not otherwise be necessary to FIGS. 9 and 10 represent situations where capacity constraints are based on serial and parallel power consumption. It should be appreciated that in some other embodiments serial and parallel power consumption may occur together and/or with additional hierarchical levels. Any suitable panel and power configuration may be used. The configuration may at least in part dictate the capacity constraints that exist and must be satisfied by the EOM in powering a flexible load. In some embodiments, the one or more EOMs operate to provide (to the extent in their control) overcurrent protection at each of the capacity constraints in the local electrical system and, in some embodiments, even assist in avoiding blackout or brownout events at the grid level (as discussed further, for example, in connection with FIG. 14). In some embodiments the capacity constraints affecting a particular EOM are input via the configuration interface, for example, at the time of installation. Though, the capacity constraints may be made available to the EOMs in any suitable way.

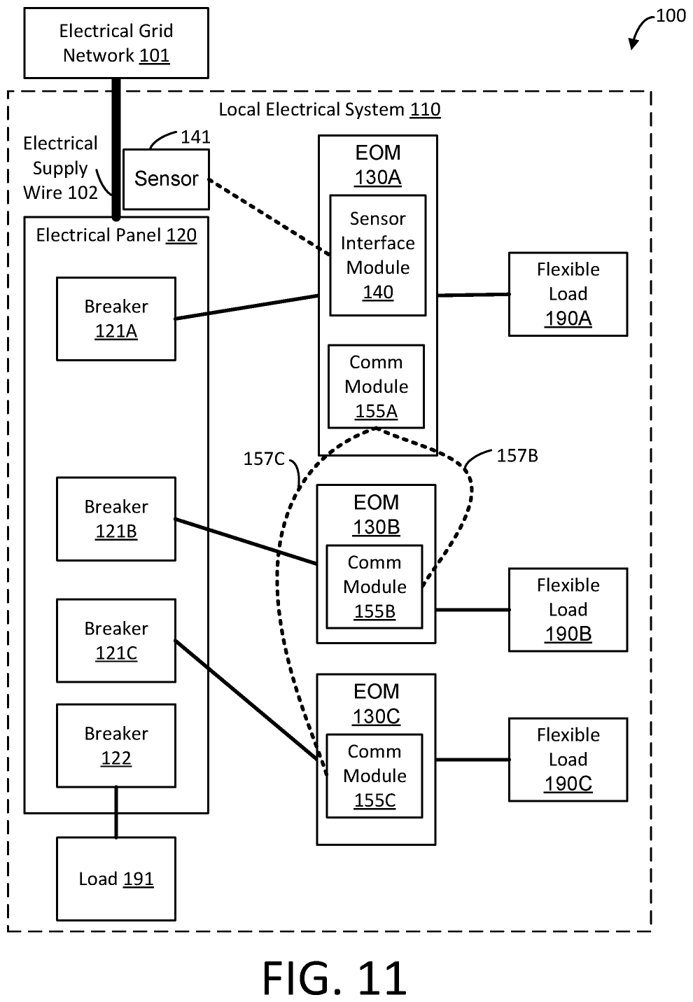

FIG. 11 shows a block diagram of another embodiment of electrical system 100 where the local electrical system 110 has multiple energy orchestration modules. Specifically, the example of three EOMs is shown, namely EOM 130A, EOM 130B, and EOM 130C. Each EOM is electrically connected to a corresponding breaker (breaker 121A; breaker 121B; breaker 121C, respectively) and a corresponding flexible load (flexible load 191A, flexible load 191B; and flexible load 191C, respectively). The use of multiple EOMs allows each of these flexible loads to be managed and controlled based on the limitations of the local electrical system 110, and a priority scheme. There may be other loads in the system such as load 191 connected to electrical panel 120 via breaker 122. Though, in some embodiments all loads on an electrical panel are instrumented by an EOM.

In this example, EOM 130A receives measurements from sensor 141 via sensor interface module 140. Though it should be appreciated that any EOM may receive the sensor measurements from sensor 141. In some embodiments, sensor 141 broadcasts the sensor measurement so that any EOM may directly receive the measurements.

In the illustrated embodiment, information is communicated by communications module 155A to communications module 155B and to communications module 155C via communications channel 157B and communications channel 157C, respectively. As illustrated, EOM 130A serves as the master with EOMs 130B and 130C. operating as slaves. In such an embodiment EOM 130A may determine exactly what operating conditions should exist based on the priority scheme and instruct the other EOMs as to their operating state. In another embodiment, EOM 130A simply passes the sensor measurement to the other EOMs for independent processing. Information about the state of the EOMs may be communicated among the EOMs via the master-slave relationship, via a peer-to-peer network, or in any other suitable way. For example, assume a simple priority scheme where each EOM is either ON or OFF and the order of priority is flexible load 190A, flexible load 190B, flexible load 190C from highest to lowest. EOM 130A may indicate over the communications channels that EOM 130A is ON (and thus flexible load 190A is being powered). EOM 130B may then use that information to determine if enough available capacity exists to power load 190B. Until a determination is made that enough capacity exists EOM 130B send an indication that it is in the OFF state. EOM 130C seeing that EOM 130B is in the off state need not do any further analysis and stays in the OFF state. (Here ON and OFF are used as short hands for powering or not powering the respective flexible load.)

Using the system 100 shown in FIG. 11 as an example, assume 60 Amps of an 80 Amp threshold capacity are in use with each of the flexible loads requiring up to 20 Amps. Assume flexible load 190 is a battery that is charged by local electrical system 110. A priority scheme might power load 190A until it is 90% charged (or some other value) and then power load 190B during the day and power load 190C at night. Though this is just an example embodiment, and any suitable priority scheme may be implemented.

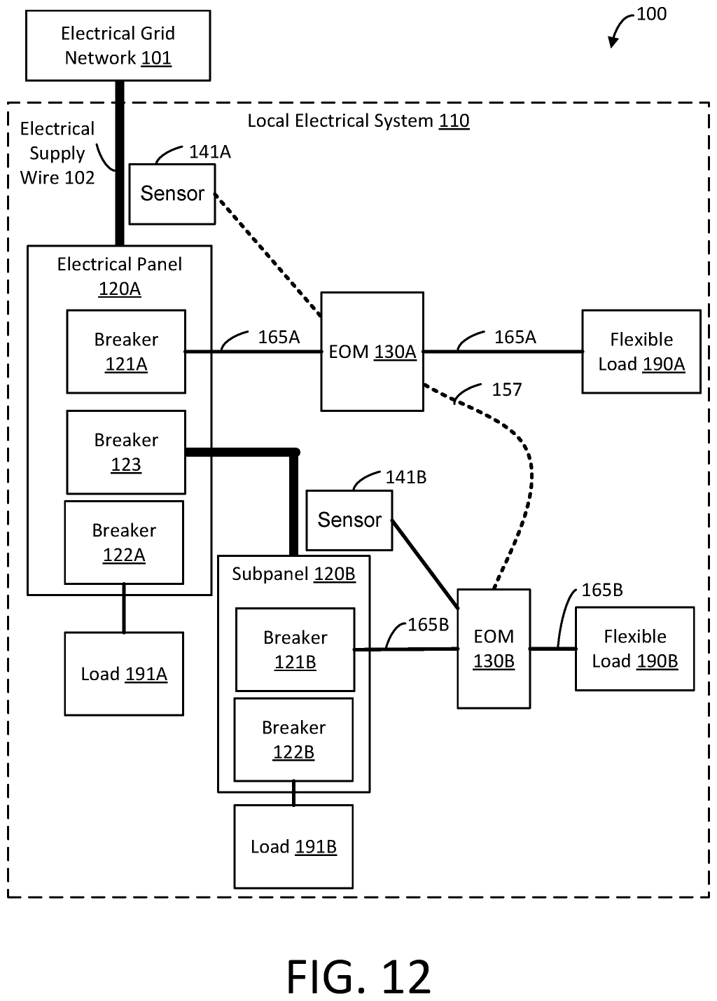

FIG. 12 shows another embodiment of system 100. In this example EOM 130A is connected to the main electrical panel 120A, while EOM 130B is connected to a subpanel 120B. Sensors 141A and 141B measure the power into electrical panel 120A and subpanel 120B, respectively. Sensors 141A and 141B are shown interfacing with EOM 130A and 130B, respectively, however, this is just illustrative and sensor measurements may be collected in any suitable way. For example, EOM 130A could receive all sensor measurements and pass information relevant to EOM 130B via communications channel 157.

In some embodiments, EOM 130A determines whether to power flexible load 190A independent of the measurement of sensor 141B, while EOM 130B determines whether to power flexible load 190B based on both the measurements of sensors 141A and 141B. This arrangement may be implemented since the powering of flexible load 190A will have a direct impact on the power provided through electrical panel 120A but will not impact the power provided through subpanel 120B, while powering flexible load 190B will impact both. In addition to simply considering whether capacity exists to power each flexible load, the EOMs may also implement a priority scheme to allocate power when it is no feasible to fully power both EOMs.

FIG. 13 provides a method 220 for allocating power in accordance with a priority scheme. Method 220 may be executed primarily by a single EOM, executed by a group of EOMs, executed by a separate computer or computers locally in communication with the EOMs, executed by a separate computer or computers in communication with the EOMs over the internet (or other network), or in any other suitable way or combination of ways. As discussed in connection with FIGS. 11 and 12, if multiple EOMs are present in a local electrical system it may be necessary to prioritize how capacity is allocated among the flexible loads. A priority scheme resolves questions of priority when power use is to be assigned based on considerations in addition capacity. A priority scheme may be used to determine what flexible loads should be load shed, modulated down in power usage, or have powering shifted in time. This may be done in favor of keeping another flexible load or set of flexible loads fully or partially powered, while meeting the capacity constraints and avoiding an overcurrent event. A priority scheme may be used, for example, when two or more EOMs or flexible loads are utilizing the same electrical supply to determine which flexible load should receive power in priority. Though, a priority scheme may even be utilized for a single device to determine when a flexible load should be powered. As an example of a priority scheme that may be used with a single device the scheme may involve only powering a flexible load if the cost of power is less than a particular value. In some embodiments the priority scheme may determine which device will receive power, and how much, when, for example, insufficient capacity exists to fully power the two or more devices. The priority scheme may be created from user input, machine learning and artificial intelligence applied to historical data, distributed by the electrical utility, or in any suitable way or combination of ways.

At step 221 of method 220 the EOMs that will be governed by a priority scheme are identified. The EOMs may be identified in any suitable way. In some embodiments, EOMs are “discovered” upon installation and added to the priority scheme upon discovery. In some embodiments, the EOMs identified are all part of the same local electrical system. In some embodiments, all the EOMs identified have one or more common capacity constraints that must be satisfied. In some embodiments, identification of the EOMs includes identification of the type of flexible load that is or may be connected to the respective EOM. In some embodiments, identification of the EOMs includes identification of the capabilities of EOM or a load controller connected to the EOM.

At step 222 of method 220 a priority scheme is selected and/or generated. The priority scheme may be generated by one or more of the EOMs, a server that commands the EOMs, or in any suitable way. In some embodiments the priority scheme is generated based on information about the EOMs and the flexible loads associated with the respective EOMs. In some embodiments the priority scheme is pre-generated and selected from a library of priority schemes. The priority scheme may be generated based on a default configuration and/or based on user specifications received through a user interface. For example, a user may specify preference for the priority scheme through a configuration interface of one or more of the EOMs, through an app or browser, or another suitable way. In some embodiments the priority scheme is generated and stored (and executed) in its entirety at each EOM. In some embodiments, the priority scheme is stored by each of the EOMs in relevant part. That is, each EOM may only receive that portion of the priority scheme logic that relates to the flexible load(s) which it controls. In some embodiments one EOM stores the priority scheme, performs all calculations and transmits control commands to the respective EOMs. Regardless of how the priority scheme is generated, checks may be made to make sure that all EOMs governed by the priority scheme acknowledge the current priority scheme so as to avoid a conflict.

In some embodiments, a priority scheme is generated that prioritizes a flexible load based on patterns in past data (e.g., usage history) for the flexible load(s) and infers when the user will use the flexible load, prioritizing a flexible load's availability at such time. As a specific example, the priority scheme may prioritize having an EV fully charged by a certain time.

In some embodiments, the priority scheme is selected based on the type of flexible loads connected to the EOMs being managed. For example, a priority scheme may give a heat pump first priority, a water heater second priority, and an EV charger third priority.

At step 223, one or more energy use rate measurements are received in ways discussed herein.

At step 224, available capacity is identified for each capacity constraint in ways discussed herein. Since multiple EOMs are present, available capacity may be reduced by capacity assigned to an EOM even if it is unused. For example, a flexible load may be allocated 30 Amps of capacity, but may only be drawing 10 Amps. In some embodiments the unused 20 Amps of capacity may be treated as reserved for the associated flexible load. Note that in order to reserve capacity in such a way, an energy use rate sensor may be required along the associated electrical path (e.g., as shown by sensor 141B in FIG. 7).

At step 225, capacity is allocated among the EOMs in accordance with the priority scheme. The priority scheme may be executed to determine the allocation of capacity in any suitable way. The EOMs may provide information needed for the execution of the priority scheme to the processor(s) executing the priority scheme. For example, the EOMs may provide information about whether a flexible load is connected to the respective EOMs. If no flexible load is connected to the EOM, the EOM may be completely deprioritized and disabled until a flexible load is connected. The priority scheme may involve any suitable criteria for allocating capacity. The criteria utilized by a priority scheme are essentially unbounded and may consider any number of factors such as user preferences (including specified preferences and observed user habits), eco-friendliness, comfort, the real-time cost of electricity, the nature of the load (e.g., can it be powered at a lower power level or does it require access to its full current rating to operate), information provided by utility operator (e.g., request to delay electricity use to avoid regional brownout or blackout), local weather, or any other criteria for which the EOM is able to obtain necessary data. In addition to energy use rate measurements, data may be pulled from other sources of information used in the priority scheme.

Capacity may be allocated in accordance with the priority scheme in ways that guard against an overcurrent event. For example, prior to utilizing a portion of the available capacity an EOM may confirm that all EOMs having a higher priority have implemented their utilization. Lower priority EOMs may temporarily delay a state change until the higher priority EOMs have established their current draw so that the available capacity can be reassessed with the enabled flexible loads drawing power. Dead bands may be utilized to prevent high frequency switching when an energy use rate would otherwise vary above and below a threshold.

As an illustrative example, one priority scheme may work as follows. Initially electrical panel and subpanel capacities and the breaker amperage are programmed into the EOM(s) at the time of installation. CTs are utilized to measure the energy use rate in each panel. For a given electrical hierarchy, a first check is made to verify that no subpanels are overloaded. For example, if the energy use rate in the subpanel exceeds 80% of subpanel capacity then the EOM attached to the subpanel will be modulated down, if it can be modulated, and turned off, if it cannot be modulated. Moving up the electrical hierarchy, if the energy use rate is less than 80% of total capacity, all flexible loads may be fully powered. If total energy usage is greater than 80% of panel capacity, power may be allocated as follows. If all flexible loads can be modulated, distribute the energy in a way that ensures each device is throttled as close as possible to the same %. For example, if three EOMs, L1, L2, L3, are all installed in one home, having flexible loads on 48A, 48A, and 30A breakers (L1MAX, L2MAX, L3MAX, respectively), and there is 60A total available power, then then turn the EOMs down by (remaining capacity)/(L1MAX+L2MAX+L3MAX)=60/(48+48+30)=47.62%. This means the flexible loads on the 48 Amp breakers are current limited to =22.8 Amps, and the flexible load on the 30 Amp breaker is current limited to 14.2 Amps. For flexible loads that cannot be modulated (e.g., heat pump), priority rankings are assigned and utilized. Flexible loads that cannot be modulated are fully powered and the modulated flexible loads are throttled to the same percentage of their respective max powers while remaining within the limits of the panel(s). It should be noted that this is merely one example and that certain assumptions hercin should be self-evident to a person of ordinary skill in the art.

FIG. 14 shows a system 300 according to some embodiments. An electrical grid network 101 services a number of local electrical systems (e.g., local electrical systems 110A, 110B, 110C) each having corresponding EOMs (e.g., EOMs 130A, 130B, 130C) and loads (e.g., flexible loads 190A, 190B, 190C). Each of the EOMs has a corresponding communications module (e.g., communications modules 155A, 155B, 155C) that communicates via a network 310 (e.g., the internet) to a central server 320.

Central server 320 may be a local computer in a physical rack, a cloud software system that communicates with the fleet of devices, or any other suitable type of computer server.

In some embodiments, central server 320 can monitor and affect the states of one or more of the EOMs at any time. It may also receive signals from external stakeholders, such as the homeowner, other homeowners, utility companies, and other third parties that are utilized in generating commands.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only. It should be appreciated that aspects of the described embodiments may be combined in some other embodiments and that such other embodiments are within the scope of this disclosure.

The above-described embodiments of the present invention can be implemented in any of numerous ways. For example, the embodiments may be implemented using hardware, software or a combination thereof. It should be appreciated that aspects of embodiments comprising computer executable commands or other logic may be implemented on any suitable device and the results communicated in any suitable way to the control hardware. For example, computational logic may be executed by an EOM, executed by a device external but in communication with the EOM, executed by a second EOM and thereafter communicated to the EOM, or in any other suitable way. When implemented in software, the software code can be executed on any suitable processor or collection of processors, whether provided in a single computer or distributed among multiple computers.

In this document, various aspects may be described functionally. While exemplary methods/algorithms may be provided, the desired functionality may be implemented in any suitable way. One of ordinary skill in the art may implement such functionality, for example, in hardware, in software, or in a combination of hardware and software. A module may comprise the hardware and/or software, to implement the functionality or algorithm disclosed. For example, in some embodiments an algorithm may be implemented through a module having one or more processors executing computer code stored on one or more non-transitory computer-readable storage media. In some embodiments, a functionality is implemented at least in part through a module having dedicated hardware (e.g., an ASIC, an FPGA). In some embodiments modules may share components. For example, a first function module and a second function module may both utilize a common processor (e.g., through time-share or multithreading) or have computer executable code stored on a common computer storage medium (e.g., at different memory locations or utilizing a common library). In some instances, a module may be identified as a hardware module or a software module. A hardware module includes or shares the hardware for implementing the capability of the module. A hardware module may include software, that is, it may include a software module. A software module comprises information that may be stored, for example, on a non-transitory computer-readable storage medium. In some embodiments, the information may comprise instructions executable by one or more processors. In some embodiments, the information may be used at least in part to configure hardware such as an FPGA. In some embodiments, an algorithm may be recorded as a software module. The capability may be implemented, for example, by reading the software module from a storage medium and executing it with one or more processors, or by reading the software module from a storage medium and using the information to configure hardware. This discussion of modules may apply to other aspects disclosed herein and the term module is not used to refer exclusively to such an implementation.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thercon can be loaded onto one or more different computers or other processors to implement various aspects of the present invention as discussed above.

In this respect, it should be appreciated that one implementation of the above-described embodiments comprises at least one computer-readable medium encoded with a computer program (e.g., a plurality of instructions), which, when executed on a processor, performs some or all of the above-discussed functions of these embodiments. As used herein, the term “computer-readable medium” encompasses only a computer-readable medium that can be considered to be a machine or a manufacture (i.e., article of manufacture). A computer-readable medium may be, for example, a tangible medium on which computer-readable information may be encoded or stored, a storage medium on which computer-readable information may be encoded or stored, and/or a non-transitory medium on which computer-readable information may be encoded or stored. Other non-exhaustive examples of computer-readable media include a computer memory (e.g., a ROM, a RAM, a flash memory, or other type of computer memory), a magnetic disc or tape, an optical disc, and/or other types of computer-readable media that can be considered to be a machine or a manufacture.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention. Computer-executable instructions may be in many forms, such as program modules,

executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

For the purposes of describing and defining the present disclosure, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue. Unless otherwise stated herein, any numerical values appeared in this specification are deemed modified by a term of degree thereby reflecting their intrinsic uncertainty.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A system comprising:
an energy orchestration module (EOM) having
a sensor interface module to receive a real-time energy use rate measurement;
an overcurrent protection mechanism to open and close an electrical path, the electrical path for delivering energy to a flexible load; and
a low-voltage control circuit operably connected to (a) the sensor interface module to receive the energy use rate measurement and (b) to the overcurrent protection mechanism, the control circuit to control the overcurrent protection mechanism to maintain an energy use rate below a threshold based on the energy use rate measurement.

2. The system of claim 1, wherein
the control circuit further generates a control signal to maintain the energy use rate below the threshold based on the energy use rate measurement; and
the EOM further comprises a communications module to send the control signal to a load controller for the flexible load.

3. The system of claim 1, further comprising:
an electrical panel connected to an energy supply wire that delivers energy into the electrical panel;
a breaker having an input side and an output side;
a current sensor to measure the energy use rate by measuring an electrical current through the energy supply wire, the current sensor operably connected to the sensor interface module;
the electrical path; and
the flexible load,
wherein
the control circuit operates on a lower voltage than that provided via the breaker;
the breaker is electrically connected to the energy supply wire on the input side and to the overcurrent protection mechanism of the EOM on the output side; and
the electrical path connects in sequence the energy supply wire, the breaker, the overcurrent protection mechanism, and the flexible load.

4. The system of claim 3, wherein the flexible load is an electric HVAC (heating, ventilation and/or air-conditioning) system.

5. The system of claim 3, wherein the EOM is a first EOM, the flexible load is a first flexible load, the breaker is a first breaker, and the electrical path is a first electrical path, the system further comprising:
a second EOM having a corresponding overcurrent protection mechanism and control circuit;
a second flexible load;
a second electrical path; and
a second breaker,
wherein
the second flexible load is electrically connected to the second EOM by the second electrical path, and
the first and second EOMs each having a respective communications module for communications therebetween, said communications to manage power delivery to the first and second flexible loads in accordance with a priority scheme while maintaining the energy use rate below the threshold.

6. The system of claim 3, further comprising a load controller for modulating power delivered to the flexible load, wherein,
the EOM further comprises a communications module for sending a control signal to the load controller; and
the control circuit generates the control signal to maintain the energy use rate below the threshold based on the energy use rate measurement at least in part by the control signal indicating to the load controller a maximum current the flexible load may draw.

7. The system of claim 6, wherein the flexible load comprises an electric vehicle (EV) charging station.

8. A system comprising:
an energy orchestration module (EOM) having
a sensor interface module to receive a real-time energy use rate measurement;
a low-voltage control circuit operably connected to the sensor interface module to receive the energy use rate measurement, the control circuit to generate a control signal to maintain an energy use rate below a threshold based on the energy use rate measurement; and
a communications module for sending the control signal to a load controller for a flexible load.

9. The system of claim 8, further comprising an overcurrent protection mechanism to open and close an electrical path, the electrical path for delivering energy to the flexible load, wherein the control circuit further controls the overcurrent protection circuit to close the electrical path if the control signal indicates the load controller should permit power delivery to the flexible load.

10. The system of claim 8, wherein
the control signal generated by the control circuit indicates an electrical current limit that the load controller is to enforce on the flexible load; and
the electrical current limit when added to a portion of the energy use rate measurement that is not attributed to the flexible load, does not exceed the threshold.

11. The system of claim 8, further comprising:
an electrical panel connected to an energy supply wire that delivers energy into the electrical panel;
a breaker having an input side and an output side;
a current sensor to measure the energy use rate by measuring an electrical current through the energy supply wire, the current sensor operably connected to the sensor interface module;
the load controller;
an electrical path; and
the flexible load,
wherein
the control circuit operates on a lower voltage than that provided via the breaker;
the breaker is electrically connected to the energy supply wire on the input side and to the load controller on the output side; and
the electrical path connects in sequence the energy supply wire, the breaker, the load controller and the flexible load.

12. The system of claim 11, further comprising an overcurrent protection mechanism connected to the electrical path between the first beaker and the flexible load, the over current protection mechanism to open and close the electrical path, wherein the control circuit further controls the overcurrent protection circuit to close the electrical path if the control signal indicates the load controller should permit power delivery to the flexible load.

13. The system of claim 11, wherein the flexible load comprises an electric vehicle (EV) charging station.

14. The system of claim 11, wherein the flexible load is an electric HVAC (heating, ventilation and/or air-conditioning) system.

15. A system for controlling a plurality of energy orchestration modules (EOMs) having a common primary energy source constraint, the system comprising:
at least one processor; and
at least one non-transitory computer-readable storage medium having stored thereon instructions that, when executed, program the at least one processor to perform a method comprising
storing a maximum primary energy use rate for the primary energy source constraint;
storing a plurality of maximum secondary energy use rates for a plurality of flexible loads, each secondary energy use rate for a respective flexible load and each flexible load having a respective EOM among the plurality of EOMs to control power delivery to the flexible load;
receiving a primary energy use rate measurement;
determining an available capacity based at least in part on the primary energy use rate measurement and the maximum primary energy use rate;
allocating at least a portion of the available capacity to at least one of the plurality of flexible loads in accordance with a priority scheme; and
instructing the respective EOM for each of the at least one of the plurality of flexible loads to which the at least a portion of the available capacity has been allocated to permit power delivery to the flexible load in accordance with the allocating.

16. The system of claim 15, wherein
the plurality of flexible loads comprises at least two flexible loads capable of receiving modulated power and the respective EOMs for the at least two flexible loads capable of modulating power delivery;
the allocating in accordance with the priority scheme comprises allocating the at least a portion of the available capacity to the at least two flexible loads such that each of the at least two flexible loads is to be powered at a same percentage of its respective maximum secondary energy use rate; and
the instructing comprises transmitting control signals from the respective EOMs for the at least two EOMs to respective load controllers for the respective flexible loads, the control signals indicating respective amounts of modulated power delivery.

17. The system of claim 15, wherein
the priority scheme identifies a first priority flexible load as having a higher priority than a second priority flexible load, the first priority flexible load controlled by a first EOM and the second priority flexible load controlled by a second EOM;
the allocating comprises allocating a first portion of the available capacity to the first priority flexible load and allocating a second portion of the available capacity to the second priority flexible load; and
the instructing comprises instructing the first EOM to permit power delivery to the first priority flexible load at the maximum secondary energy use rate for the first priority flexible load and instructing the second EOM to permit power delivery to the second priority flexible load at a rate below the maximum secondary energy use rate for the second priority flexible load.

18. The system of claim 15, wherein
the priority scheme identifies a first priority flexible load as having a higher priority than a second priority flexible load, the first priority flexible load controlled by a first EOM and the second priority flexible load controlled by a second EOM;
the allocating comprises allocating a first portion of the available capacity to the first priority flexible load and allocating a second portion of the available capacity to the second priority flexible load, and
the instructing comprises instructing the first EOM to permit power delivery to the first priority flexible load at the maximum secondary energy use rate for the first priority flexible load and instructing the second EOM to permit power delivery to the second priority flexible load at the maximum secondary energy use rate for the second priority flexible load.

19. The system of claim 15, wherein
the priority scheme identifies a first priority flexible load as having a higher priority than a second priority flexible load, the first priority flexible load controlled by a first EOM and the second priority flexible load controlled by a second EOM;
the second priority flexible load is not equipped to receive modulated power delivery;
the allocating comprises allocating the portion of the available capacity to the first priority flexible load and determining a remaining portion of the available capacity is insufficient to fully power the second priority flexible load; and
the instructing comprises instructing the first EOM to permit power delivery to the first priority flexible load at the maximum secondary energy use rate for the first priority flexible load and instructing the second EOM to prevent power delivery to the second priority flexible load.

20. The system of claim 15, wherein
the priority scheme identifies a first priority flexible load having priority over a second priority flexible load which itself has priority over a third priority flexible load, wherein the second priority flexible load is not equipped to receive modulated power delivery;
the allocating comprises allocating a first portion of the available capacity to the first priority flexible load and allocating a second portion of the available capacity to a third priority flexible load; and
the instructing comprises instructing the first EOM to permit power delivery to the first priority flexible load at the maximum secondary energy use rate for the first priority flexible load, instructing the second EOM to prevent power delivery to the second priority flexible load, and instructing the third EOM to permit power delivery to the third priority flexible load at a rate below the maximum secondary energy use rate for the third priority flexible load.
